(19) United States
(12) Patent Application Publication
(10) Pub. No.: US 2007/0078769 A1
(43) Pub. Date: Apr. 5, 2007

(54) Anti piracy system in a peer-to-peer network

(75) Inventor: Benjamin B. Way, London (GB)

Correspondence Address: KNOBBE MARTENS OLSON & BEAR LLP, 2040 MAIN STREET, FOURTEENTH FLOOR, IRVINE, CA, 92614, US

(73) Assignee: STEMVENTURES LIMITED, London (GB)

(21) Appl. No.: 10/563,787

(22) PCT Filed: Jun. 24, 2004
(86) PCT No.: PCT/GB04/02754

§ 371 Date: Jul. 10, 2006

(30) Foreign Application Priority Data
Jul. 7, 2003 (GB) 0315886.2

(51) Int. Cl. G06Q 99/00

(52) U.S. Cl. 705/51

(57) ABSTRACT

A system for combating file piracy via peer-to-peer networks, comprising a plurality of terminal devices 1000a-1000c each running a client program arranged to emulate a peer-to-peer user is disclosed.

### CROSS REFERENCE TO RELATED APPLICATIONS

This application is a U.S. National Phase of International Application No. PCT/GB2004/002754, filed Jun. 24, 2004, which claims the benefit of United Kingdom Application No. 0315886.2, filed Jul. 7, 2003, the specifications of which are herein incorporated by reference in their entirety.

### BACKGROUND OF THE INVENTION

This invention relates to systems and methods for prevention of piracy of digital files. It is well known that music (and other copyright material such as films) is widely available on the Internet via “file sharing” or “peer-to-peer” (“p2p”) systems. Piracy through these has been very difficult to prevent by traditional methods.

Peer-to-peer networks are a type of transient Internet network that allows a group of computer users, with the same networking program, to connect with each other and directly access files from one another's hard drives. Once installed, a p2p user's computer finds another network member on-line, and it can connect to that user's connection. Users can choose how many members connections to seek at one time, and determine which files they wish to share. Users can search for specific files via sophisticated keyword search. For example, music files can be found by artist's name or track title. To ensure the fastest and most reliable connection, the p2p software on the user's computer locates several instances of the same file from multiple different locations. The user can therefore download segments of the same file from multiple different hard drives of other users.

Various technical approaches to reducing the problems of piracy via file sharing have been considered. A first consists of “spoofing”; that is, spreading fake files such as corrupted, incorrectly named, or blank files to p2p networks, to make it harder for people to find music. GB 2372416 discloses a method of spoofing by downloading a file from the Internet, corrupting the file, and then redistributing it. GB 2371898 discloses a method of corruption using encryption and U.S. Pat. No. 6,732,180 (published after the present priority date) also relates to spoofing.

The recording industry association (RIAA) has developed software which enables it to find users swapping unauthorised copies of songs on the Internet and sends instant messages that pop up on their computer screens with a copyright infringement warning. However, this method depends upon the conscience of the users.

New releases of peer-to-peer networks have attempted to resist spoofing by including IP blocking, and there are also third party products such as a program called PeerGuardian or Peer Guardian which were developed to block IP addresses of those seeking to spoof or otherwise attack the p2p networks. It therefore renders the process of sending messages or false files to the p2p networks largely ineffective.

### SUMMARY OF THE INVENTION

Certain embodiments provide an improved method of countering distribution of pirate digital files through p2p networks.

One embodiment is a system configured to combat file piracy via peer-to-peer networks. The system includes a plurality of terminal devices each running a client program arranged to emulate a peer-to-peer user.

Another embodiment is a system configured to discourage piracy of files over peer-to-peer networks. The system includes a terminal device arranged to emulate a peer-to-peer user, to receive a request to download a file, to commence downloading at a first data rate, and, after a time, to reduce the data rate to a second data rate, where the second data rate is lower than the first data rate.

Another embodiment is a system configured to combat file piracy via peer-to-peer networks. The system includes a first terminal device arranged so as to detect a peer-to-peer user computer offering a pirated file, and a second terminal device is arranged to download the file at a data rate lower than the maximum data rate possible.

Another embodiment is a method of reducing piracy of digital files via peer-to-peer computer networks. The method includes providing a plurality of screen saver programs, distributed between a plurality of terminal devices, the screen saver programs being arranged to emulate peer-to-peer user computer programs.

Another embodiment is a method of reducing piracy of digital files via peer-to-peer computer networks. The method includes offering files appearing to be pirated files for download by peer-to-peer users, initially downloading the offered files at a first data rate, waiting for a period sufficiently long to cause acceptance of the download by the peer-to-peer network, and then reducing the data rate to a second, slower, data rate.

Another embodiment is a method of reducing piracy of digital files via peer-to-peer computer networks. The method includes offering for download by a peer-to-peer user a segment of a file, the offered segment appearing to be a segment of a pirated file, and downloading data which is different than the segment of the pirated file to the user.

### BRIEF DESCRIPTION OF THE DRAWINGS

Embodiments of the invention will now be described, by way of example only, with reference to the accompanying drawings in which:

FIG. 1 is a block diagram showing the components of an embodiment of the invention;

FIG. 2 is an illustrative diagram showing a known p2p network;

FIG. 3 is a flow diagram showing the process performed by the server computer of FIG. 1 in registering and maintaining a work to be protected;

FIG. 4 is a flow diagram showing the process of loading and executing a screen saver on a terminal computer of the system of FIG. 1;

FIG. 5 (comprising FIGS. 5a and 5b) is a flow diagram showing the process performed by the screen saver to search for pirated files in a first embodiment; and

FIG. 6 (comprising FIGS. 6a and 6b) is the corresponding process in a second embodiment;

FIG. 7 is a flow diagram showing the process performed by the screen saver in providing decoy files for downloading for p2p users;

FIG. 8 is an illustrative diagram showing the reduction in bandwidth during the process of FIG. 7;

FIG. 9 is an illustrative diagram showing the process of downloading file segments in a known p2p network;

FIG. 10 shows the process performed by the screen saver of the system of FIG. 1 in downloading a decoy segment; and

FIG. 11 corresponds to FIG. 9 and shows the effect of the process of FIG. 10;

FIG. 12a is a flow diagram showing the process performed by a first screen saver to provide file interdiction;

FIG. 12b is a flow diagram showing the responsive process performed by the server of FIG. 1; and

FIG. 12c is a flow diagram showing the responsive process performed by a second screen saver;

FIG. 13 is an illustrative diagram showing the effects of the process of FIG. 12;

FIG. 14 is a flow diagram showing the process of file exchange performed by screen savers according to the embodiment;

FIG. 15 is an illustrative diagram showing the communication channels between screen savers;

FIG. 16 is an illustrative diagram showing the program components present on a terminal computer of FIG. 1; and

FIG. 17 is an illustrative diagram showing the communications from a screen saver program of the system of FIG. 1.

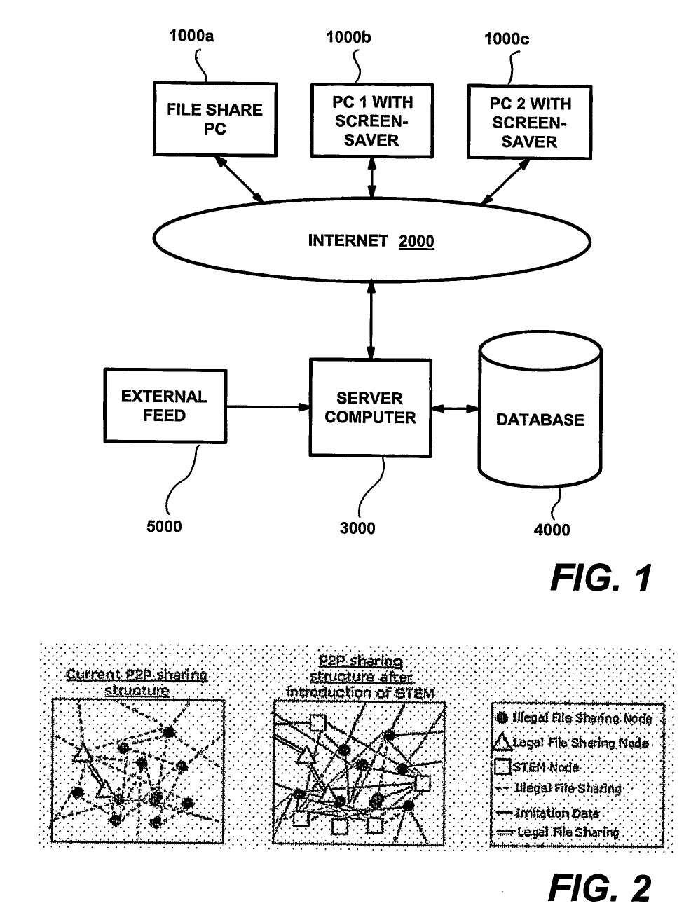

### DETAILED DESCRIPTION OF CERTAIN INVENTIVE EMBODIMENTS

The present embodiments consist of two types of software; software configured to run on a server 3000, and software configured to run, as a screen saver, on a plurality of Internet user computers 1000a-1000c. Each such Internet user computer running a screen saver is referred to as a node or an agent.

The server contains a database 4000 which holds a list of protected files and protected material definition, as well as statistical information and updates. The server also hosts an interface which allows owners of copyright works to manage and protect their material externally, through a secure website (not described in detail herein), from an external feed 5000.

The nodes are deployed via the screen saver. They search for files corresponding to those works stored on the server database 4000, checking against the protected material definitions (i.e. data associated with the protected works). The nodes then connect to p2p networks and emulate p2p users but instead of offering genuine files, only files containing false information are made available; and instead of downloading files at the fastest possible rate (as would a genuine p2p user) downloads are performed at a variable rate reducing towards the slowest possible rate, so as to tie up the p2p user connections.

The screen saver contains runs on nodes which attack p2p networks as discussed above; it also regularly requests updates of protected material definitions from the server, checks for software updates, uploads performance data and statistics to the server and acts as a communications channel between the system and users who have installed the screen saver on their PC. By default it will become active whenever a computer is not being used by its owner but the owner can, however, define the screen saver settings, activating it manually or presetting it to run at specific times.

Referring to FIG. 2, certain embodiments provide screen saver nodes which appear to act as a peer-to-peer computers, in sufficient numbers to swamp illegal file sharing nodes whilst not interfering with those conducting exclusively legal file sharing.

Identifying New Works To Be Protected

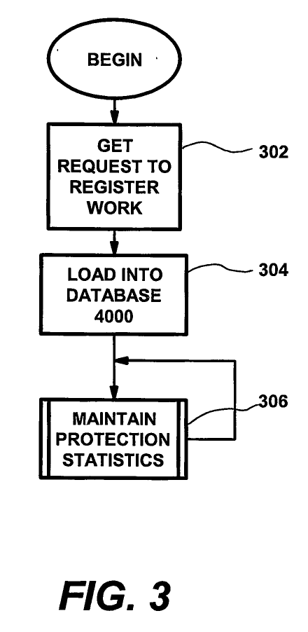

Referring to FIG. 3, in step 302, the server 3000 receives a request from an external data source to protect a new work. It supplies information concerning the work. This might be the name of a song, and/or (if the work has already been distributed in electronic form) the name of the file, length of the file and so on.

In step 304, the server 3000 creates a new entry in the database 4000 for the new work, and loads any file characteristic data (such as length of the file, file title and so on) into the record. Thereafter, in a process shown generally as subroutine 306, the server maintains statistics for the work indicating the level of piracy of the work, and the number of acts performed to defend against piracy as discussed in greater detail below, based on information received from the screen savers 1000a, 1000b . . .

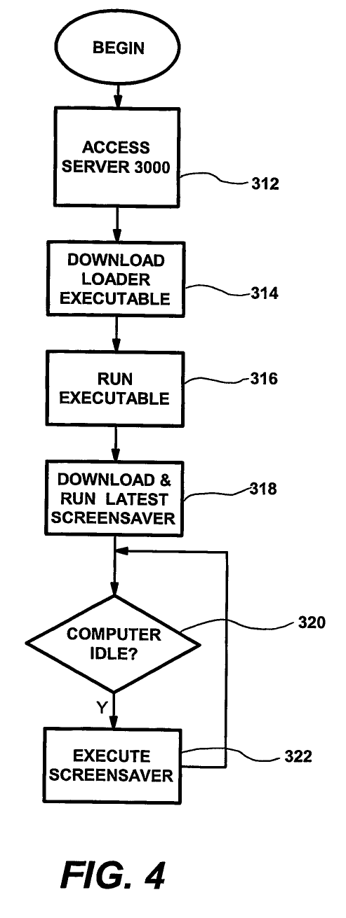

Referring to FIG. 4, when a new user wishes to become a node in the anti piracy system, in step 312 the user causes their browser to access the server 3000 (e.g. by clicking on a URL) and in step 314, an executable file comprising a loader program is downloaded from the server 3000 to the user terminal 1000a. In step 316, the user runs the loader program. The loader program then, in step 318, contacts the server 3000 to download the latest version of the screen saver program and install it as a screen saver on the computer. Thereafter, the screen saver program is executed whenever the computer becomes idle (shown illustratively as steps 320 and 322, but in practice controlled by the operating system such as Windows™).

Imitation Data Download

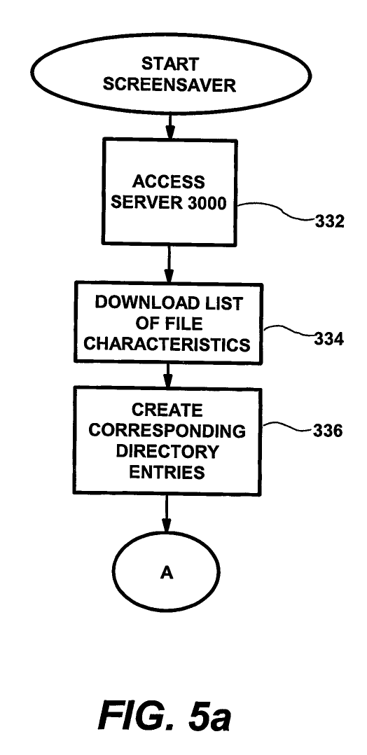

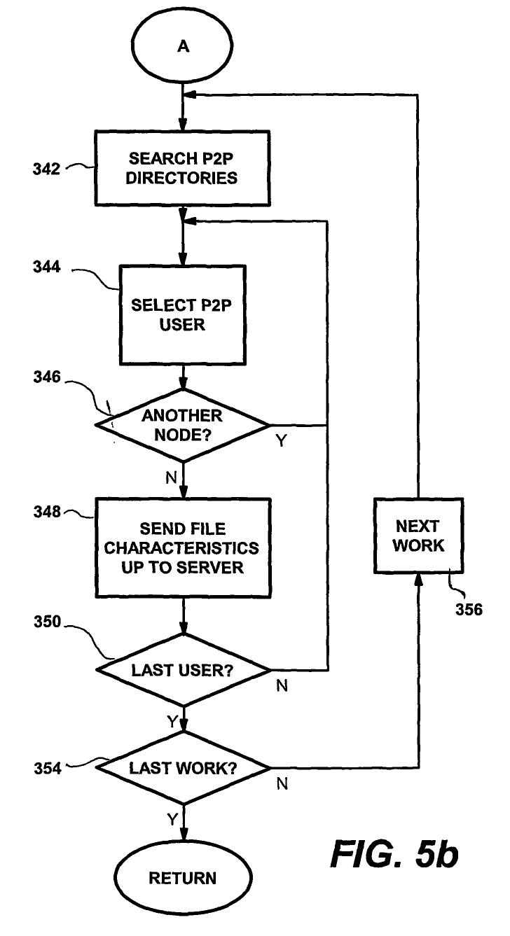

Referring to FIG. 5a, when the screen saver is started (step 322 of FIG. 4), it accesses the server computer 3000 (step 332) which accordingly downloads a file containing a list of pirated files and their characteristics (for example, file name, file size, file type and so on). In step 336, the screen saver program then creates a set of corresponding entries in a dummy file catalogue. The dummy file catalogue will be accessible, as if it were a real file catalogue, by p2p users as will be discussed in greater detail below.

Referring now to FIG. 5b, the screen saver next performs a data acquisition process. In step 342, the screen saver, emulating a p2p user, searches the directories of p2p users for a protected file, using file characteristic data, such as for example key words such as the title of the work or the name of the artist. In step 344, a first p2p user is selected. In step 346, the screen saver determines, from a list it holds, whether the apparent p2p user is in fact another screen saver node. If it is then the screen saver returns to step 344 to select the next p2p user.

Otherwise, in step 348, the screen saver sends the characteristics of the file detected (file name, file size, file type and any other available data) to the server 3000. Returning to step 344, the next p2p user is selected and the process is repeated until all users storing files located in the search are finished (step 350). The next protected work is then selected (step 356) until all protected works have been searched for (step 354) which point the data acquisition routine stops. It is repeated periodically whilst the screen saver is operating, so as to provide continuous data acquisition by all screen savers. At the server, the data thus transmitted is stored in the database 4000 ready to be downloaded (step 334 of FIG. 5a) on the next occasion when each screen saver is started.

This data acquisition process provides realistic information on available files sizes which is constantly updated, for use as described below. It will be seen that the use of the check in step 346 permits nodes to mutually identify each other so that they will not constantly be seeking out protected material apparently residing on other screen saver nodes; they can thus tell the difference between decoy or dummy files and real, pirated files and thereby avoid a feedback loop in which each node would attack others.

Data Acquisition

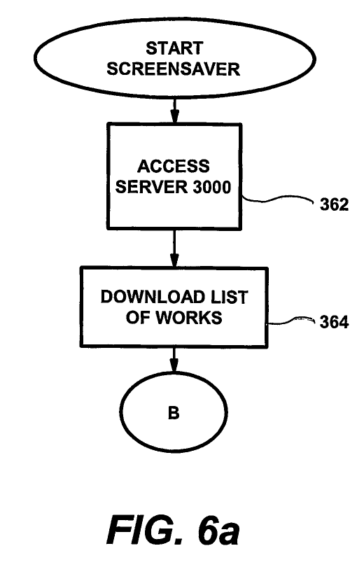

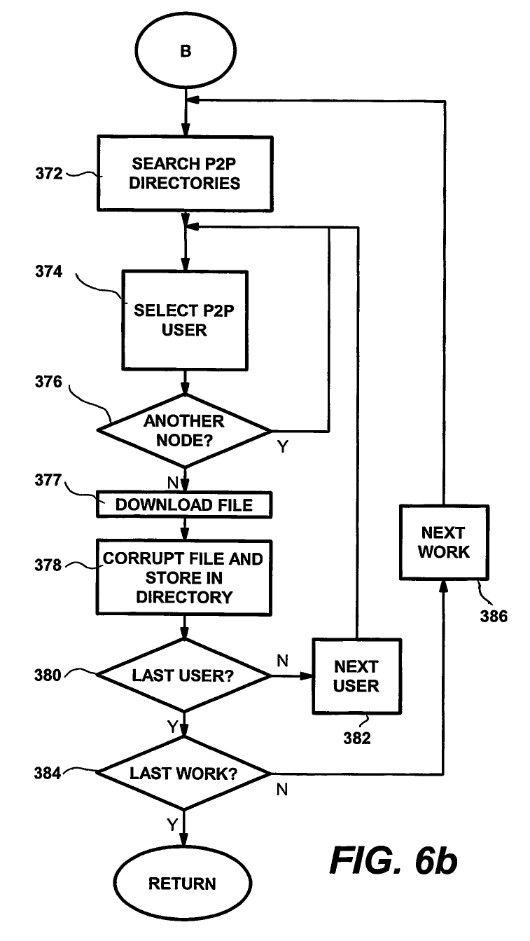

Referring to FIG. 6, the data acquisition process will now be described.

Referring to FIG. 6a, when the screen saver is started, it accesses the server computer 3000 in step 362 and downloads the list of protected works in step 364, with, in each case, characteristic data such as the name of the work or the artist.

Referring to FIG. 6b, in step 372, the screen saver searches the p2p network for the protected work, using the characteristic data such as keywords, artist name, name of the work and so on. In step 374, one of the p2p users found in the search is selected and in step 376, it is determined whether the p2p user is another node. If so, as before, the next user is selected by returning to step 374.

If not, then in step 377, the screen saver, emulating a p2p program, downloads the file from the selected user, and in step 378 the file is corrupted as to render it unintelligible, and store in a dummy directory (as in the preceding embodiment) as an entry with the same file name and size as the downloaded file. This process is repeated, as in the preceding embodiment, for each p2p user, and then for each other protected work (steps 380-386). Periodically, each such corrupted file is further corrupted and stored, so as to make it more difficult to identify as a known spoof data file.

Progressive Bandwidth Reduction (“Stemming”)

Each screen saver node in use progressively reduces the amount of a bandwidth by which it downloads files to p2p users over time. When p2p users start downloading files they will often monitor the speed at which the file is being downloaded. If the connection speed is too slow or too fast, the p2p user will normally cancel the file download session, and find a faster site to download from. According to the some embodiments, this is avoided by starting file download at an acceptable speed, but then reducing the amount of bandwidth subsequently.

This inconveniences p2p users by tying them into slow downloading sessions, and also reduces the inconvenience to the owner of the computer on which the screen saver is running by using only a small portion of the available bandwidth.

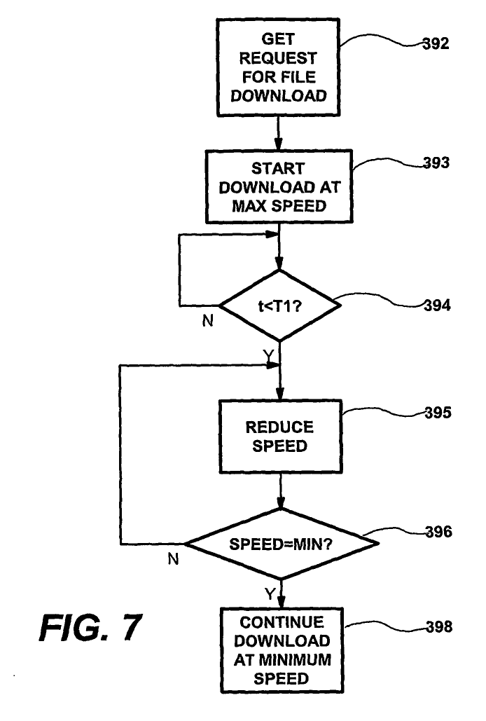

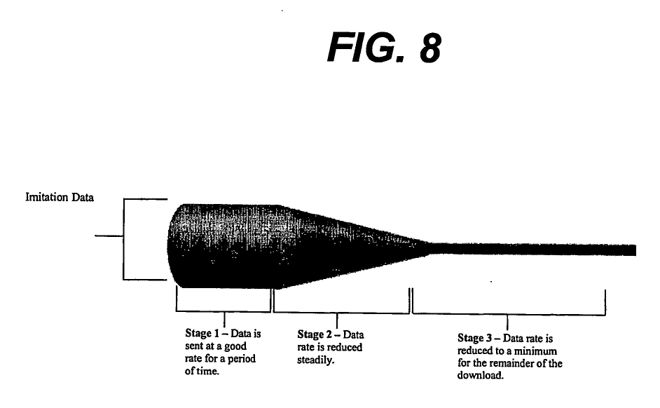

Referring to FIG. 7, in step 392, the screen saver program receives, from a p2p user computer, a request for download of a file contained within its dummy catalogue. In step 393, download of data commences at the maximum bandwidth available through the modem or line adapter of the computer 1000. In step 394, when a first time interval T1 is reached, the data rate is reduced (step 395)—for example by increasing the interval between the sending of each packet. The speed reduction continues progressively until a minimum speed is reached (step 396). The minimum speed is just sufficient that the p2p user computer will not time out and close the connection. Downloading of data continues at this minimum speed (step 398) endlessly, or until the file has completed downloaded, or until the screen saver is terminated or the p2p user terminates the session. The effect of this is illustrated in FIG. 8; the initial period lasts long enough to avoid the p2p user terminating the session straightaway, but in the end the p2p user is inconvenienced by the apparent download.

Supply of Dummy File Segments

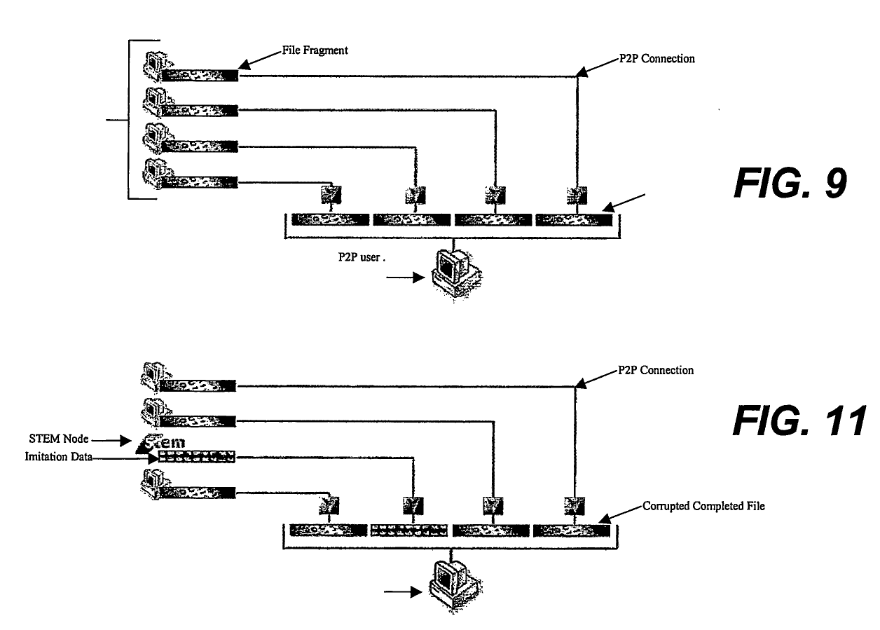

P2p networks often provide functionality which, when a p2p user downloads a file, automatically seeks out multiple other p2p users from whom to download the file in segments, so as to speed up the download process. This is illustrated in FIG. 9.

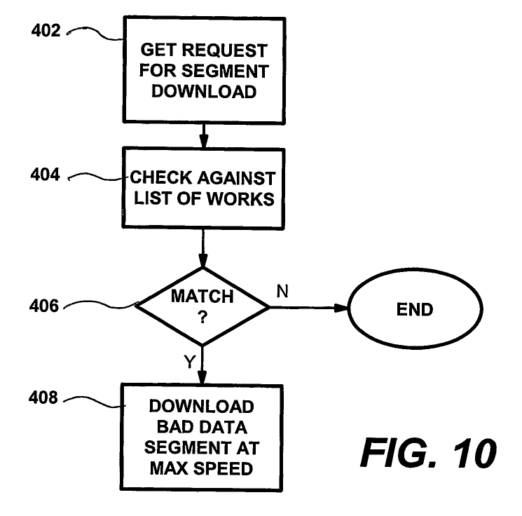

Referring to FIG. 10, in step 402, the screen saver node receives a request from the file sharing network for download of an identified segment. In step 404, the segment is checked against the list of protected files held at the screen saver. If there is no match (in other words, if the user is seeking to download a file not known to be pirated) then in step 406 the process is terminated.

If a match is found in step 406, then in step 408, a segment of corrupt data of the same size as that requested by the p2p network is downloaded, at the maximum bandwidth available. The corrupt data may have any contents, provided that it matches the segment length expected by the p2p user. As shown in FIG. 11, when the corrupt segment is assembled with the rest of the file download from elsewhere, the result is a corrupted file. In this case the data may be downloaded at maximum speed, rather than a reduced speed as disclosed above, so as to maximise the chance that the file downloaded by the user is corrupted, rather than run the risk that the p2p network will abandon the download of the corrupt segment.

It would also be possible, in this process as in those discloses above, to initially check whether the segment request originates from another screen saver node.

Overloading P2p User Connections

Many p2p user programs have a parameter determining the maximum number of connections it can handle, thus limiting the number of computers which can download from that user at anyone time. Typically, the number of single user simultaneous connections is set at 100 so that only 100 users can be downloading information at any one time. The screen saver nodes from the present invention can create multiple connections to a p2p user who has illegal information on their computer, such that once the number of connections has reached the maximum number of connections for that user, it will be impossible for other p2p users to download from that user. Each screen saver node can provide multiple connections running at their minimum bandwidth in each case, so that relatively little bandwidth is required to attack p2p users by this means.

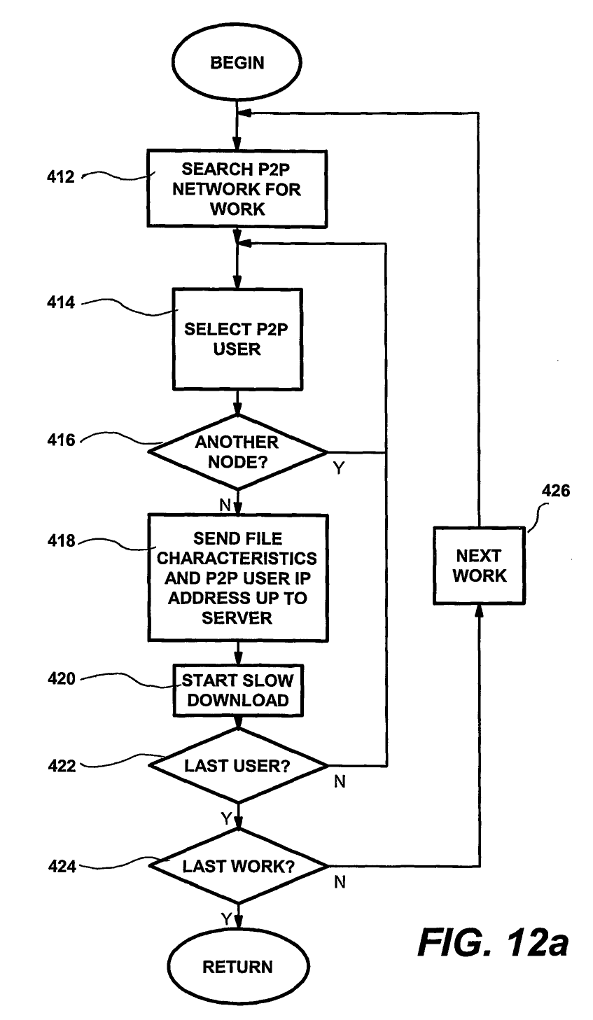

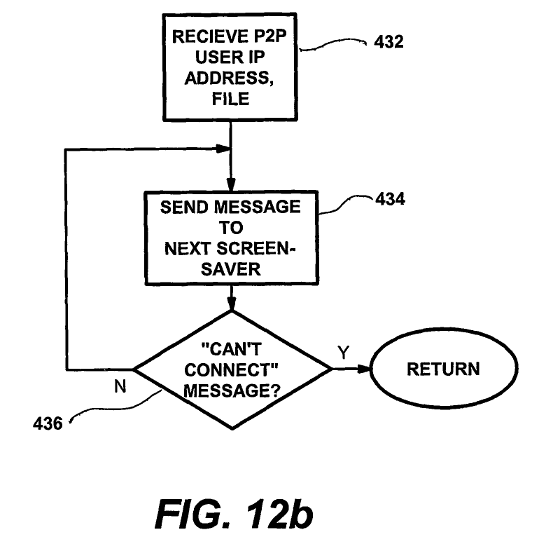

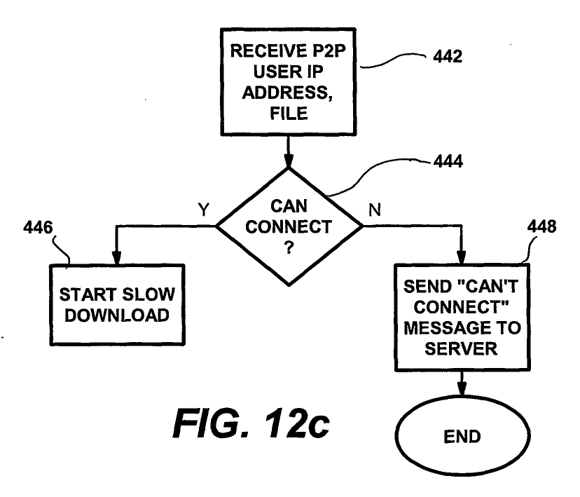

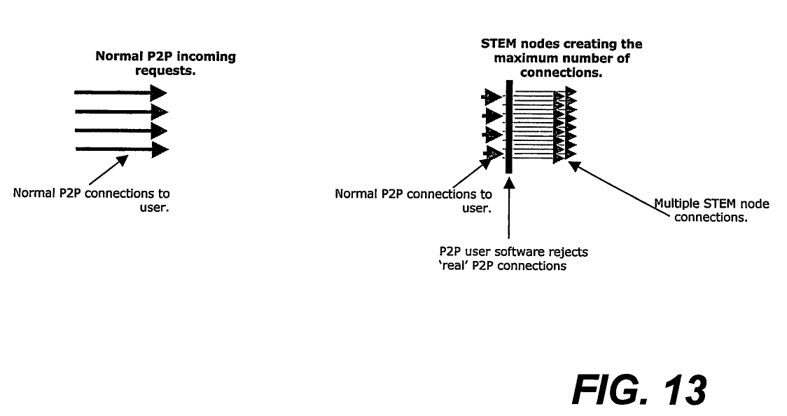

Referring to FIG. 12, in FIG. 12a the process of locating a p2p user is shown. In step 412, the screen saver selects a protected work and searches the p2p network for that work. In step 414, from the p2p users located on the search, a user is selected. In step 416, as above, it is determined whether the apparent p2p user is in fact another screen saver node. If so, the process returns to step 414 to select the next p2p user.

Otherwise, the file characteristics and the IP address of the p2p user are transmitted up to the server 3000 (for reasons which will be discussed below) in step 418. Next, in step 420, the screen saver node connects to the p2p user and starts to download the file at its minimum possible connection speed. This ensures that the connection will be in place for a long period of time. In reception, the file is not stored but discarded (to avoid creating further copies of the protected work and using disk space on the computer hosting the screen saver). If (step 422) other users are found who have the work in question stored, the process returns to step 414 to select the next user. Otherwise, if (step 424) other protected works exist, a further protected work is selected (step 426) and the process returns to step 412 to search the network for that work.

The processes for selecting p2p user (step 414) and protected work (step 426) may incorporate a pseudo-random selection mechanism, so that different screen savers attack users in different orders; alternatively, each screen saver may be provided by the server 3000 with a different (or differently ordered) list of protected works to achieve the same effect.

Referring to FIG. 12b, at the server 3000, on receiving a message from a screen saver computer 1000a (transmitted in step 418 discussed above) in step 432, the server sends a message to another screen saver 1000b in step 434 specifying the IP address of the p2p user and the file details. If, in step 436, the server 3000 receives from the computer 1000b a message indicating that the computer cannot connect to the p2p user computer, this server process terminates (on the basis that the p2p user is now inaccessible, which is probably due to its maximum number of connections being reached). If no such message is received, then the server returns to step 434, selects a further screen saver computer 1000c, and sends the message to the further screen saver computer, and so on until it receives in step 436 a “can't connect” message from a screen saver computer.

The server will always continue to queue a small number of further screen savers ready to replace any which desist from the attack.

Referring to FIG. 12c, at each such further screen saver computer 1000b, 1000c . . . the message transmitted from the server in step 434 is received (step 442). In step 444 the screen saver computer then attempts to request the file from the identified p2p user (step 444). If connection is possible, the screen saver computer 1000b starts downloading the file at the minimum possible rate (step 446) and if no connection is possible (e.g. because the p2p user has already reached its maximum number of possible connections) then in step 448, the screen saver sends a message back to the server computer 3000 to indicate that a connection was not possible.

It will thus be apparent that this aspect of the invention works similarly to a denial of server attack. It would be possible to use more sophisticated algorithms for deciding which p2p users to attack: for instance, the server computer could, before executing step 434, determine whether the p2p user concerned has stored and is offering more than one (or, in general, more than N) protected files, so as to target p2p users who flagrantly disregard copyright and contractual restrictions.

Mutual P2P Rating Amplification

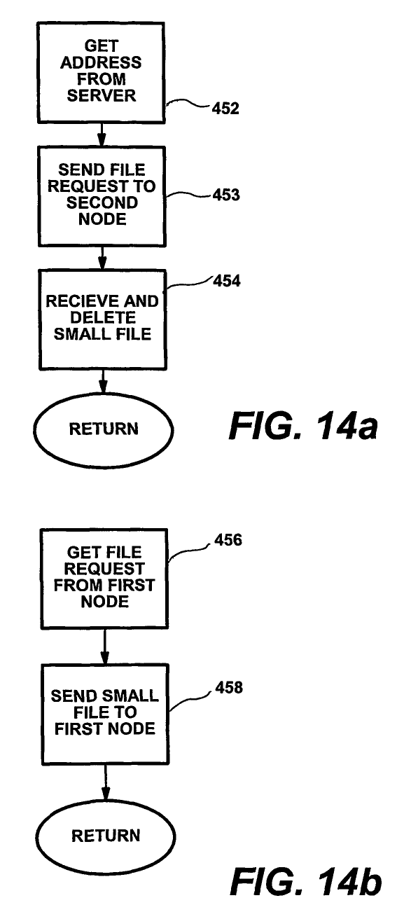

Some p2p networks use ratings to judge how reliable and fast a p2p user's connection is, and how many files they share and take. It is convenient for a screen saver nodes of the present invention to be given a high rating, so that they will be selected by p2p users for preferential supplying and downloading of files. Accordingly, referring to FIG. 14, in step 452, a first screen saver node 1000a signals to the server computer 3000 to get the IP address of a second screen saver node 1000b, and in step 453 the first node sends to the second screen saver node a request to download an identified file through the p2p network. In step 454, it receives from the second node a small file, and deletes it.

In step 456, the second node 1000b receives the file request from the first node and sends a small file to the first node (in step 458). The screen saver nodes therefore periodically exchange small files through the p2p network, thereby mutually amplifying their ratings without using too much of their available bandwidth.

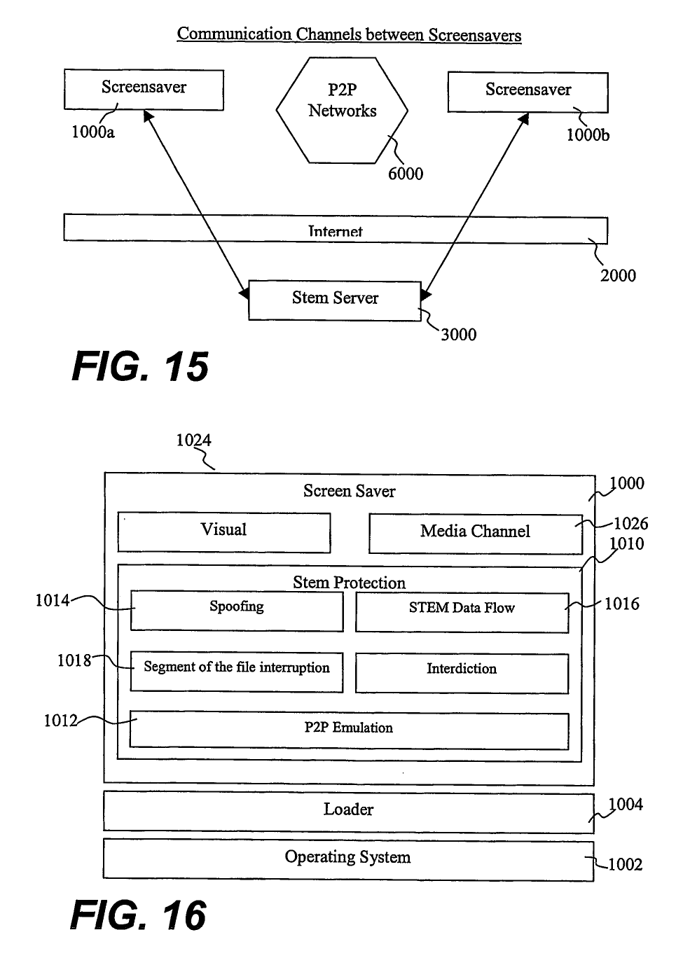

FIG. 15 shows the communication channels between screen savers. Screen saver computers 1000 communicate with the server 3000 via the Internet 2000. The use of this architecture has several advantages. Distributing the processing between a large number of different computers makes it harder to block the IP addresses concerned, particularly since in most cases, temporary IP addresses will be allocated to the private Internet users who will host the screen savers. The fact that the computers will be in normal use part of the time will further make it difficult for p2p networks 6000 to locate and defeat the attack. At the same time, the use of screen savers ensures that the nodes do not intrude into the normal use of those private users. In some embodiments some operations, such as minimum bandwidth downloading of files, can continue even when normal use of the computer has recommenced and other aspects of the screen saver have shut down, since they will make a minimal impact on the bandwidth available to the user.

FIG. 16 shows diagrammatically the software components present on a screen saver computer 1000. An operating system 1002 (such as Windows™ or Linux™) provides access to the computer resources, and also communication resources such as a TCP/IP stack.

A loader program 1004 (as discussed above) is arranged to download new versions of the screen saver. A screen saver program 1010 comprises a p2p network emulation program 1012, arranged to provide dummy file directories, accept requests for downloads, generate requests for downloads, and search for files in the manner of a p2p client program. A spoofing module 1014 performs the processes described above in relation to FIG. 6a or 6b. A data flow module 1016 performs the process described above in relation to FIGS. 7 and 8. A file segment interruption module 1018 performs the process described above in relation to FIGS. 10 and 11. An interdiction module 1019 performs the process described in relation to FIGS. 12a and 12c.

Also provided is a visual module 1024 for generating a screen display to the user (which may either illustrate the performance of the node in attack p2p networks or show unrelated images—either 2d or 3d) and a media channel 1026 for data to be communicated to the user of the screen saver.

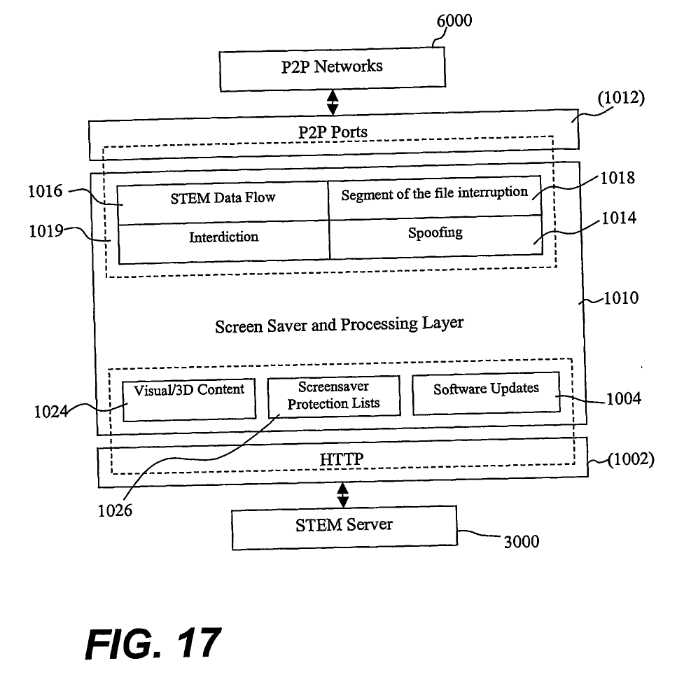

As shown in FIG. 17, the modules 1014-1019 communicate through p2p ports forming part of the p2p emulation program 1012 with the p2p network 6000, whereas the visual module 1024, lists of protected works, files and other nodes 1026, and the loader 1004 communicate via hypertext transfer protocol (http) through the TCP/IP stack forming part of the operating system 1002, with the server 3000.

The software of the server 3000 comprises an operating system such a Unix, running programs for supplying screen saver software and updates thereto; and performing the processes as described above. By providing regular software updates, the protection system can stay ahead of the p2p networks and attempt to protect piracy taking place over them. The screen savers may also be arranged to upload performance data and statistics to the server 3000 which thereby monitors their performance (statistics may show, for example, how long the screen saver had been connected, how many files have been protected).

The server is be arranged to provide a password protected web based interface to the database 4000 to allow companies to update their protected material definition automatically as well as adding new protected works.

Clients may pay a fee for protection of their works, and owners of screen saver computers 1000 may be given loyalty incentives which include, for example, discounts, entry to competitions or monetary consideration, which could be linked to the statistics uploaded by screen savers (such as the amount of time the screen saver has been active) which could be communicated through the media channel.

Protected material may take any form which could include, but is not limited to music files, video files, ebooks and software. The software updates include, but are not limited to, security updates, protocol and parameter updates, protected material update and statistical information updates. Protected material definitions, which are used by the system, may include track name, artist name, movie title, associate search name phrase, common misspellings associates with the protected material, or other relevant material. A digital finger printing module such as that available from ‘Audible Magic’ could be added to further enhance file identification.

Although four separate protection mechanisms have been described above, and could be used separately, greater protection may be achieved by using them together, and each node is capable of monitoring a significant number of p2p users, preventing them from operating effectively. Even if far fewer nodes than p2p users are active at any one time, a significant level of protection can still be provided. Some aspects operate only against particular files to be protected, thus allowing legitimate file sharing uses of p2p networks to continue, but other aspects could allow complete denial of service to a p2p network.

The server 3000 can supply operating parameters to control the screen saver so as, for example, to activate the screen saver on a particular computer only at particular times of the day—this can be used to balance the load between different users computers so that computers in different time zones are only operated when the user is unlikely to be using them.

Protection is hereby sooughtt for any and all novel subject matter and combination thereof disclosed herein. The present invention extends to any and all variants of the above described techniques that would be apparent to the skilled person. For example, networks other than the Internet (such as mobile networks) and terminals other than computers (such as mobile phones) could be used.

1. A system configured to combat file piracy via peer-to-peer networks, the system comprising a plurality of terminal devices each running a client program arranged to emulate a peer-to-peer user.

2. A system according to claim 1, wherein said client program comprises a screen saver program, arranged to start execution on detecting cessation of activity by computers users of the terminal device.

3. A system according to claim 1 further comprising a server computer arranged to communicate with the terminal devices.

4. A system according to claim 3, wherein the server computer is configured to communicate via the Internet with the terminal devices.

5. A system according to claim 3, wherein the server computer is arranged to maintain a list of works to be protected against piracy, and to supply at least part of said list to said terminal devices.

6. A system according to claim 3, wherein the server computer is arranged to receive data from the terminal devices indicating one or more peer-to-peer users performing at least one of making pirated files available, and making available details of pirated files held by said one or more users.

7. A system configured to discourage piracy of files over peer-to-peer networks, the system comprising a terminal device arranged to emulate a peer-to-peer user, to receive a request to download a file, to commence downloading at a first data rate, and, after a time, to reduce the data rate to a second data rate, wherein said second data rate is lower than said first data rate.

8. A system according to claim 7 in which the terminal device is arranged to receive a request for a segment of a file, the segment comprising only a portion of said file, and to transmit data which does not correspond to said segment so as to corrupt said file.

9. A system configured to combat file piracy via peer-to-peer networks, the system comprising a first terminal device arranged so as to detect a peer-to-peer user computer offering a pirated file, and a second terminal device is arranged to download said file at a data rate lower than the maximum data rate possible.

10. The system of claim 9, wherein said first terminal device is arranged to instruct the second terminal device to request to download said file.

11. The system of claim 10, wherein said first terminal device is arranged to signal to a server computer the identity of the peer-to-peer user computer and the identity of the file, and the server computer is arranged to signal to at least a second terminal device the identity of said peer-to-peer user and the identity of said file, and said second terminal is arranged to request the download of said file from said peer-to-peer user computer.

12. (canceled)

13. A method of reducing piracy of digital files via peer-to-peer computer networks, the method comprising providing a plurality of screen saver programs, distributed between a plurality of terminal devices, said screen saver programs being arranged to emulate peer-to-peer user computer programs.

14. A method of reducing piracy of digital files via peer-to-peer computer networks, the method comprising offering files appearing to be pirated files for download by peer-to-peer users; initially downloading said offered files at a first data rate; waiting for a period sufficiently long to cause acceptance of the download by the peer-to-peer network; and then reducing the data rate to a second, slower, data rate.

15. A method of reducing piracy of digital files via peer-to-peer computer networks, the method comprising:
offering for download by a peer-to-peer user a segment of a file, the offered segment appearing to be a segment of a pirated file; and
downloading data which is different than said segment of the pirated file to the user.

16. (canceled)

17. (canceled)

18. (canceled)

19. A system according to claim 1, wherein at least one terminal device is arranged to offer a file which appears to be a file requested by a peer-to-peer user, and to supply said file to the peer-to-peer user, wherein the file is different than the requested file.

20. A system according to claim 7, wherein the terminal device is arranged to respond to the request by downloading a file which appears to be the requested file, wherein the downloaded file is different than the requested file.

21. A computer arranged as a terminal device for the system according to claim 1.

22. A computer readable medium comprising instructions, which, when executed on a computer, result in the computer performing as the terminal device of the system according to claim 1.

23. A computer arranged as a terminal device for the system according to claim 7.

24. A computer readable medium comprising instructions, which, when executed on a computer, result in the computer performing as the terminal device of the system according to claim 7.

25. A computer arranged as a terminal device for the system according to claim 9.

26. A computer readable medium comprising instructions, which, when executed on a computer, result in the computer performing as the terminal device of the system according to claim 9.

27. A computer arranged as a server for the system according to claim 5.

28. A computer readable medium comprising instructions, which, when executed on a computer, result in the computer performing as the server computer of the system according to claim 5.

29. A computer arranged as a server for the system according to claim 6.

30. A computer readable medium comprising instructions, which, when executed on a computer, result in the computer performing as the server computer of the system according to claim 6.

31. A computer arranged as a server for the system according to claim 11.

32. A computer readable medium comprising instructions, which, when executed on a computer, result in the computer performing as the server computer of the system according to claim 11.
